(19) United States
(12) Patent Application Publication
(10) Pub. No.: US 2003/0210982 A1
(43) Pub. Date: Nov. 13, 2003

(54) Multi-rotor ceiling fan structure capable of stably revolving round a central axis thereof

(76) Inventor: Chia-Teh Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/141,831

(22) Filed: May 10, 2002

(51) Int. Cl. F03D 11/00

(52) U.S. Cl. 416/5

(57) ABSTRACT

A multi-rotor ceiling fan structure capable of stably revolving round a central axis thereof, which comprises a rotating disk fixedly joined with one or more rotating arms, an inner housing cover fixedly disposed on the rotating disk, a central axial rod fixedly joined at the ceiling, and a power transmission set. A fan is pivotally disposed at each end of the rotating arm. The lower end of the central axial rod passes through the centers of the rotating disk and the inner housing cover, and is tightly slipped onto a bearing structure placed between the centers of the rotating disk and the inner housing cover. A seat body having a conductor of the power transmission set is fixedly disposed on the inner housing cover. A conductive sleeve of the power transmission set is slipped onto the central axial rod. The conductor keeps electric contact with the conductive sleeve.

### FIELD OF THE INVENTION

The present invention relates to a multi-rotor ceiling fan structure capable of stably revolving round a central axis thereof and, more particularly, to a multi-rotor ceiling fan structure, which exploits rotation of fan blades of each rotor pivotally disposed at opposite outer ends thereof to drive the whole ceiling fan to stably and smoothly revolve round a central axis thereof without vibration and sway.

### BACKGROUND OF THE INVENTION

US. Pat. No. 6,364,638 B1 discloses a double-rotor (or multi-rotor) ceiling fan structure, wherein a pair of rotating arms or more are installed with a rotating disk as the center, and fans are pivotally disposed at two ends of the rotating arms, which symmetrically protrude out of the opposite sides of the rotating disk. Moreover, an upward central axial rod is vertically connected at the center of the rotating disk so as to be hung at the ceiling.

As shown in FIGS. 1 and 2, a multi-rotor ceiling fan structure of this prior art comprises a central axial rod 11 hung at the ceiling, a rotating disk 12 movably and pivotally disposed at the tail end of the central axial rod 11, a power transmission set 20 composed of a conductive sleeve 21 and a seat body 22 and connected to a power source, and a rotating braking set 30 composed of a central gear 31, a pivotal seat 32, a pivot 33, a spring 34, a deceleration gear 35, and a rubbing component 36. More than two sets of fans (not shown) are disposed at outer sides of the rotating disk 12. The conductive sleeve 21 is fixedly slipped onto the central axial rod 11. Some conductors 23 connected to the fans are disposed on the seat body 22, which is fixedly disposed on the rotating disk 12. The conductors 23 keep electric contact with the conductive sleeve 21. The central gear 31 is slipped onto the central axial rod 11. The pivotal seat 32 passes in order through the spring 34, the deceleration gear 35, and the rubbing component 36 with the pivot 33, and is then fixedly disposed on the rotating disk 12. The deceleration gear 35 can keep meshing the central gear 31 on the central axial rod 11.

The rotation braking set 30 in the prior art has two objects, deceleration of revolution and stabilization of revolution (without vibration and sway). For deceleration of revolution, the rotation braking set 30 is exploited to let the fan set and the rotating disk 12 including the rotating arms bear considerable load and friction when rotating and thus leading to revolution, hence achieving the effect of deceleration to let the speed of revolution be not too quick. For stabilization of revolution, tight meshing of the deceleration gear 35 and the central gear 31 is exploited to form a rotation fulcrum, which builds a stable rotation platform with the rotation center of the rotating disk 12 so the phenomenon of sway and instability will not occur when the fan set rotates and thus leads to revolution. This prior art has the following drawbacks.

1. There is noise when the fan set rotates and leads to revolution. Because the central gear 31 with a larger bore needs to be fixedly slipped onto the central axial rod 11, it is necessary to axially lock in a screw thereafter to achieve fixing object. The central gear 31 thus fixed does not always coincide with the center of the central axial rod 11 in the first place or it is unavoidably displaced and shifted after a period of use. In the other words, the central gear 31 easily becomes eccentric over time (i.e., not align with the rod center of the central axial rod 11). As a consequence, the deceleration gear 35 does not revolve along a circular orbit when revolving the central gear 31, but revolves along an eccentric elliptic orbit. Sometimes these two gears will mesh too tight, and sometimes they won't contact each other at all resulting in intermittent noise.

2. The malfunction rate is too high. Because of excessive eccentricity, the two gears will jam each other so revolution is not possible. Or because of rustiness of the two gears, the friction will be too large so revolution becomes impossible.

3. The bottom side of the deceleration gear 35 is resiliently supported by the spring 34, which will push the deceleration gear 35 to press the rubbing component 36. The rubbing component 36 will press the pivotal seat 32 to generate friction force so as to achieve the effect of deceleration. But this complicated deceleration structure will spoil smoothness of revolution, not mentioning the drawback of pause or sudden rotation because of eccentricity.

4. Because the rubbing component 36 for generating deceleration effect is inevitably made of rubber material, it will age and deform because of heat caused by friction after a certain time of use, hence resulting in the phenomenon of not smoothness or malfunction, or even causing fire due to over heat.

5. The maintenance expense is high. In order to reduce failure rate in use, it is necessary to perform regular lubrication and maintenance to the gears 31 and 35, adjust the eccentric phenomenon of gear, and replace the aged rubbing component. The maintenance work is time-consuming, and does not conform to economic benefit.

In consideration of the above drawbacks, the deceleration and stabilization functions to revolution of the rotation braking set disposed in the prior art is not satisfactory enough. The present invention aims to propose a multi-rotor ceiling fan structure to resolve the problems in the prior art.

### SUMMARY OF THE INVENTION

The primary object of the present invention is to provide a multi-rotor ceiling fan structure capable of stably revolving round a central axis thereof, which, without the original gear type rotation braking set, can avoid every drawback in the prior art. The present invention can maintain both effects of deceleration and stable revolution without the installation of gear structure. Moreover, consumers can enjoy wind from all directions through individual fan rotation coupled with the system revolution.

Another object of the present invention is to provide a multi-rotor ceiling fan structure capable of stably revolving round a central axis thereof, wherein an illumination lamp can be further disposed below the ceiling fan for indoor illumination.

To achieve the above objects, the present invention provides a multi-rotor ceiling fan structure capable of stably revolving round a central axis thereof, which comprises a rotating disk fixedly joined with one or more rotating arms, an inner housing cover fixedly disposed on the rotating disk, a central axial rod fixedly joined at the ceiling, and a power transmission set. A fan is pivotally disposed at each end of the rotating arm. The lower end of the central axial rod passes through the centers of the rotating disk and the inner housing cover, and is tightly slipped onto a bearing structure placed between the rotating disk and the center of the inner housing cover. A seat body having a conductor of the power transmission set is fixedly disposed on the inner housing cover. A conductive sleeve of the power transmission set is slipped onto the central axial rod. The conductor keeps electric contact with the conductive sleeve. The bearing structure is exploited to replace the gear structure of the prior rotating braking set to perform the function of stabilization and deceleration for revolution.

The various objects and advantages of the present invention will be more readily understood from the following detailed description when read in conjunction with the appended drawing, in which:

### BRIEF DESCRIPTION OF THE DRAWINGS

FIG. 1 is a partial structure diagram of U.S. Pat. No. 6,364,638 B1;

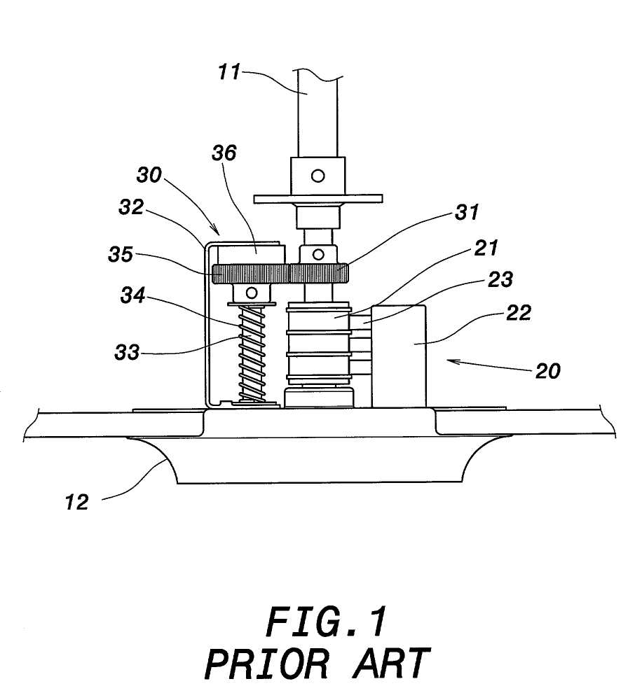

FIG. 2 shows an action state diagram according to FIG. 1;

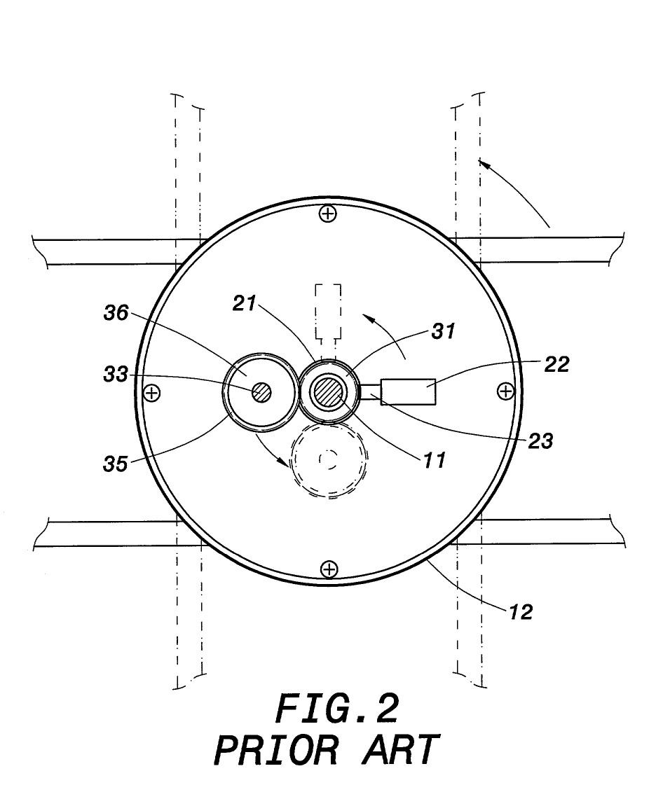

FIG. 3 is an exploded perspective view of the present invention;

FIG. 4 is a perspective view of the present invention after almost assembled;

FIG. 5 is a perspective view of the present invention after completely assembled;

FIG. 6 is a partial cross-sectional view of the present invention;

FIG. 7 shows an action state diagram of the present invention;

FIG. 8 is a top view of a rotating arm according to a first embodiment of the present invention;

FIG. 8A is a top view of a rotating arm according to a second embodiment of the present invention;

FIG. 8B is a top view of a rotating arm according to a third embodiment of the present invention; and

FIG. 8C is a top view of a rotating arm according to a fourth embodiment of the present invention.

### DETAILED DESCRIPTION OF THE PREFERRED EMBODIMENTS

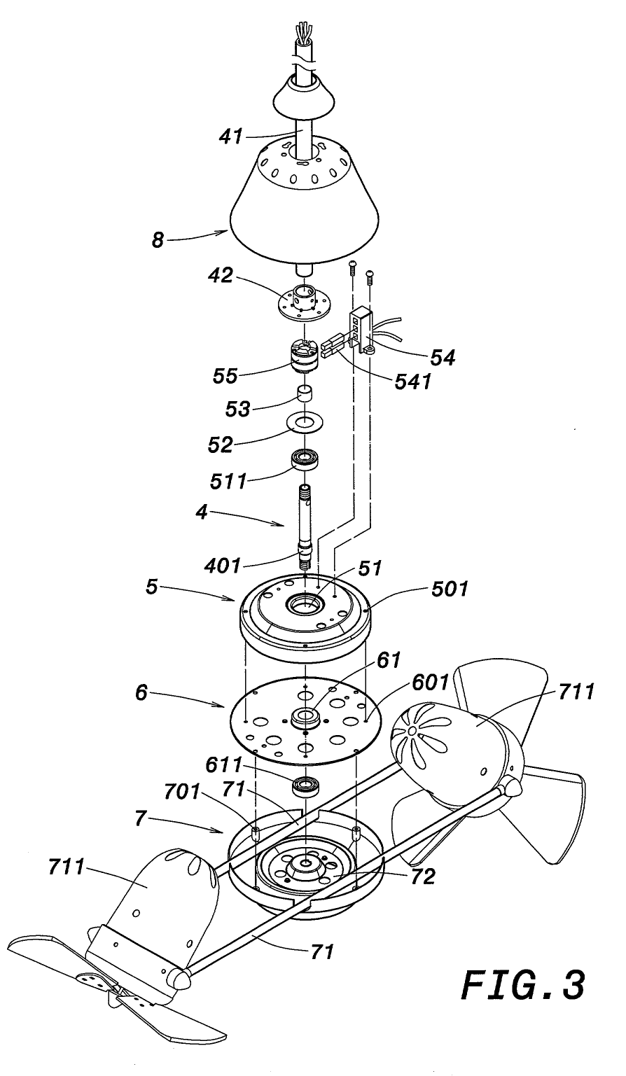

As shown in FIGS. 3, 4, and 5, the present invention provides a multi-rotor ceiling fan structure capable of stably revolving round a central axis thereof. In order to have the function of stable revolution, the ceiling fan structure mainly comprises a central axial rod 4, an inner housing cover 5, a rotating disk 6, several rotating arms 71, and a plurality of fans 711.

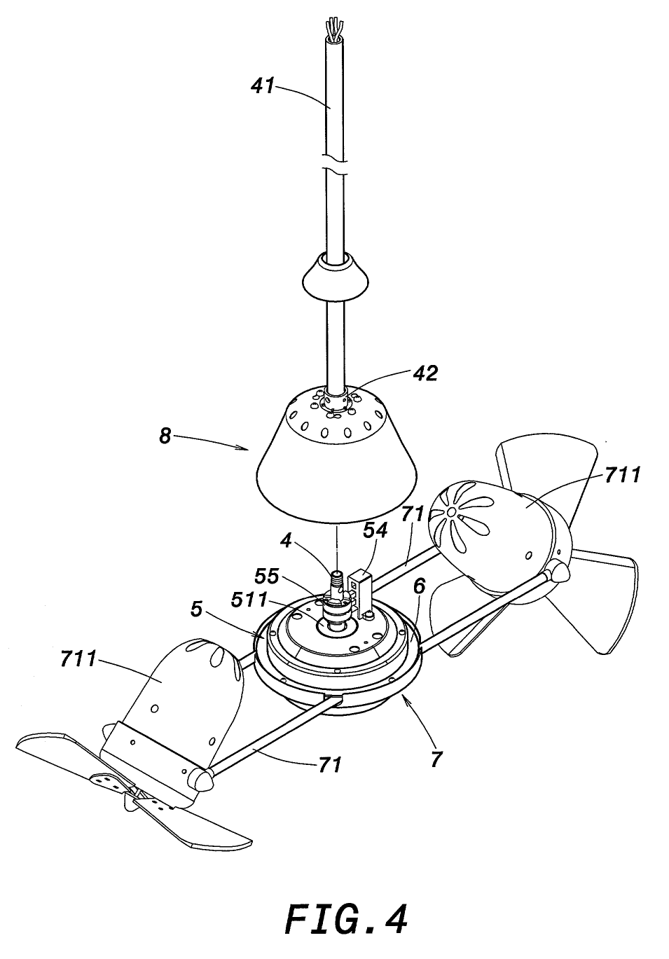

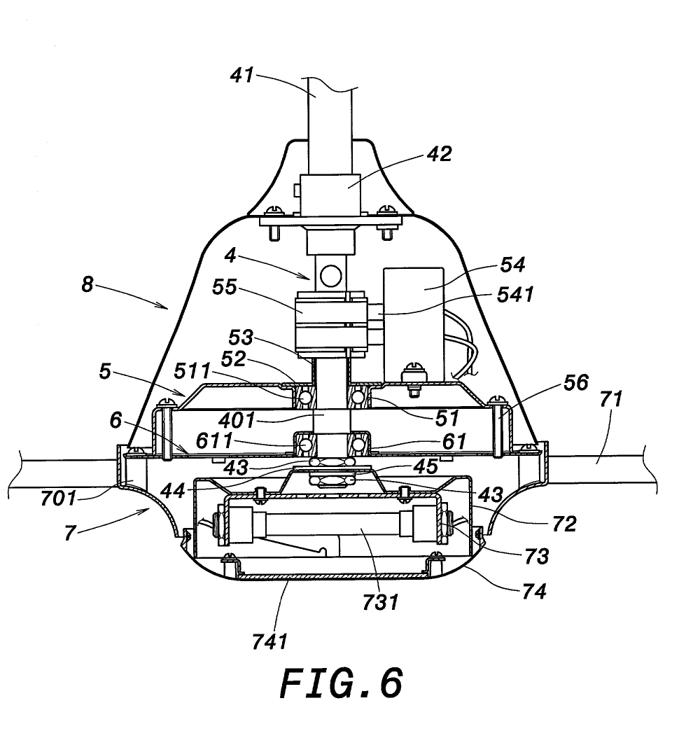

Please refer to FIG. 6 and also FIGS. 3 and 4, the rotating arms 71 are fixedly joined at the bottom side of the rotating disk 6 in a way not shown in the figures (or the rotating arms 71 are fixedly disposed through the assembly of the inner housing cover 7 and the rotating disk 6 described below). The fans 711 are pivotally disposed at two ends of the rotating arms 71.

The inner housing cover 5 is fixedly disposed on the rotating disk 6. The inner housing cover 5 and the rotating disk 6 have several corresponding screw holes 501 and 601, respectively. Fixing components 56 are used to screw the inner housing cover 5 onto the rotating disk 6.

The central axial rod 4 can be fixedly joined at the ceiling directly, or a boom 41 whose upper end is fixedly joined at the ceiling can mate with the central axial rod 4 through an engaging head 42. The lower end of the central axial rod 4 passes through the centers of the inner housing cover 5 and the rotating disk 6, and is tightly slipped onto a bearing structure placed between the centers of the inner housing cover 5 and the rotating disk 6. The bearing structure can be a lengthwise multi-row bearing, or can be composed of two single-row bearings 511, 611. The only requirement is that the height of the multi-row bearing can reach the sum of heights of the two single-row bearings. In this embodiment, two single-row bearings 511 and 611 are used. The two bearings 511 and 611 are placed in a recessed portion 51 on the top face at the center of the inner housing cover 5 and a projective portion 61 on the top face at the center of the rotating disk 6, respectively. The inner housing cover 5 and the rotating disk 6 can thus stably rotate simultaneously. A ringed projective portion 401 is formed at the portion of the central axial rod 4 between the inner housing cover 5 and the rotating disk 6 so that the two single-row bearings can be separated up and down.

A power transmission set comprises a seat body 54, a conductor 541, and a conductive sleeve 55. The seat body 54 can be a carbon brush seat. The conductor 541 can be a carbon brush. The seat body 54 having the conductor 541 is fixedly disposed on the inner housing cover 5. The conductive sleeve 55 is slipped onto and fixed at the outer edge of the central axial rod 4. The conductor 541 keeps contact with the conductive sleeve 55.

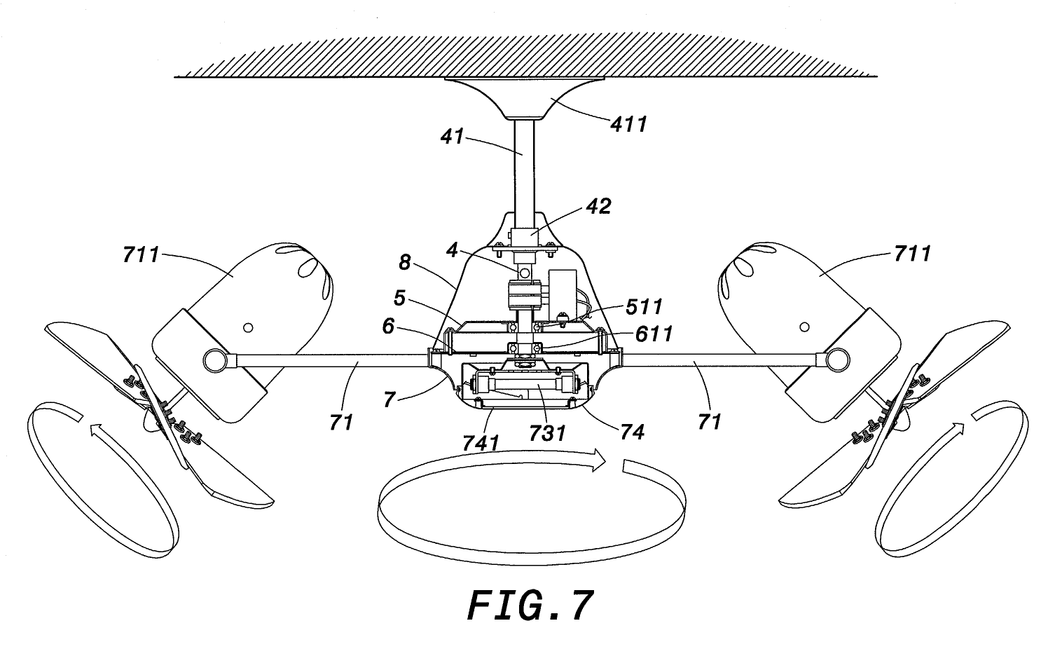

As shown in FIGS. 6 and 7, when blades of the fans 711 start rotating, the rotating disk 6 is led to revolve round a central axis thereof the central axial rod 4 due to influence of the wind flow of the fans 711 (the rotating arms 71 drives the rotating disk 6 and the inner housing cover 5 to rotate, but the central axial rod 4 does not revolve). Because a lengthwise multi-row bearing or the two single-row bearings 511 and 611 can be installed at the vertically-joined portion of the lower end of the central axial rod 4 with the inner housing cover 5 and the rotating disk 6, the inner housing cover 5, the rotating disk 6, the rotating arms 71, and the fans 711 can synchronously revolve round a central axis thereof, hence achieving stable rotation without any vibration and sway.

If there are two symmetric fans 711, a two-rotor ceiling fan is formed. If there are three fans spaced by 120 degrees one another, or four fans spaced by 90 degrees one another, a three-rotor or a four-rotor ceiling fan is formed.

Please refer to FIGS. 3 and 6, a bushing 53 can further be slipped onto the central axial rod 4 between the conductive sleeve 55 and the bearing 511, and a cover board 52 can further be slipped onto the central axial rod 4. The cover board 52 covers above the recessed portion 51 of the inner housing cover 5. The cover board 52 and the inner housing cover 5 are fixed together by means of point welding. An engaging head 42 can further be fixedly joined at the upper end of the central axial rod 4. The other end of the engaging head 42 is fixedly joined with a boom 41. The upper end of the boom 41 is fixedly joined at the ceiling to further connect an upper housing cover 8 through the engaging head 42. The upper housing cover 8 thus covers the periphery of the central axial rod 4 and the inner housing cover 5.

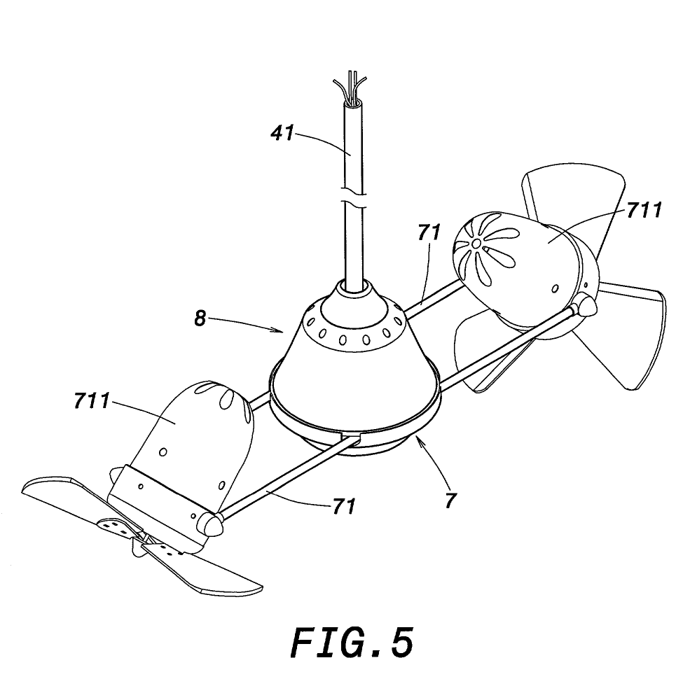

As shown in FIGS. 3 and 6, in order to having the function of illumination, the rotating arms 71 can be mounted on a lower housing cover 7. A plurality of post bodies 701 are vertically disposed at the inner periphery of the lower housing cover 7. The rotating disk 6 is screwed to the post bodies 701 through fixing components like screws so that the rotating disk 6 and the lower housing cover 7 can fix each other. A lamp disk 72 in the lower housing cover 7 can be fixedly disposed at the lower end of the central axial rod 4 protruding out of the bottom side of the rotating disk 6 through a hexagonal nut 43 or a flat gasket 44 and a dentiform gasket 45. A lamp socket 73 joining a lamp body 731 is fixedly disposed in the lamp disk 72. The wires of the lamp body 731 are stuck into the central axial rod 4, protrude out of the upper end of the boom 41, and then are connected to the public power network or a control switch not shown in the figure. A lampshade 74 is fixedly disposed at the lower opening of the lower housing cover 7. A glass 741 is fixedly disposed at the lower opening of the lampshade 74. A ceiling fan structure of the present invention shown in FIG. 5 is thus formed.

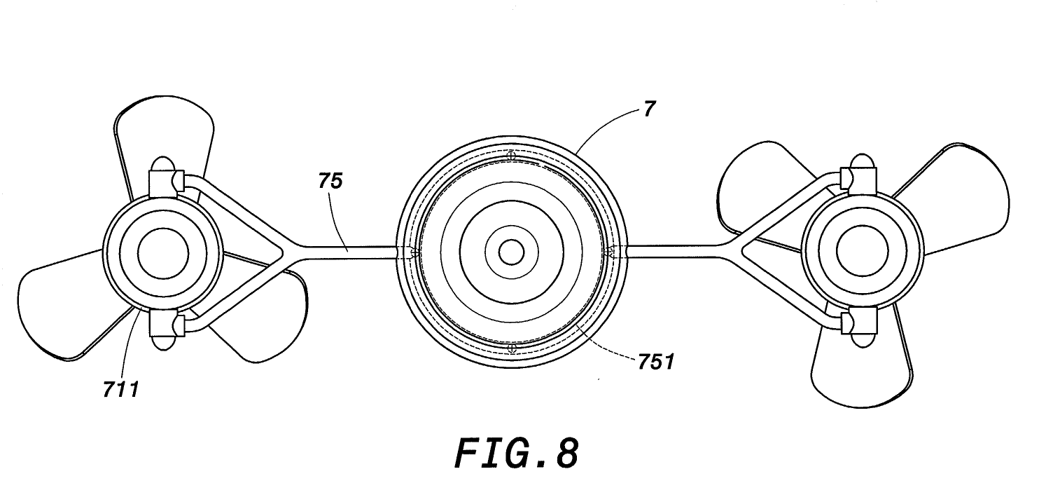

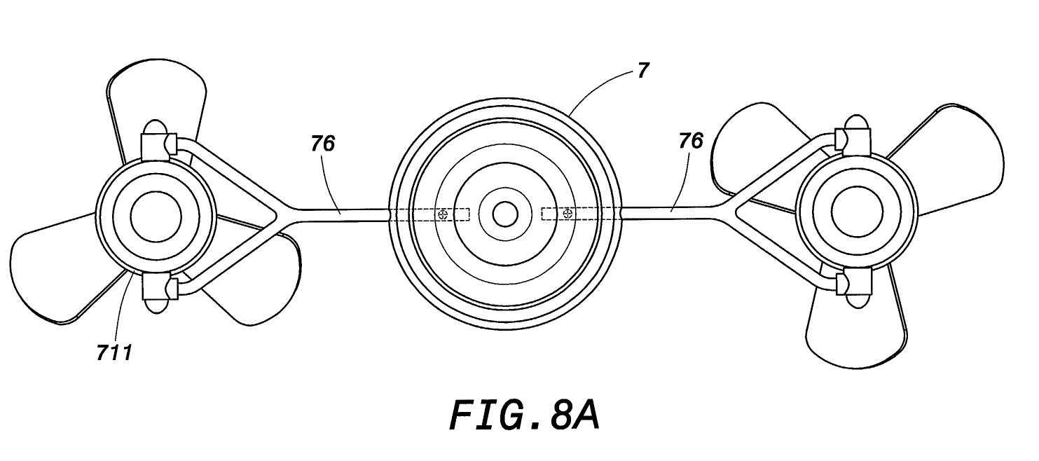

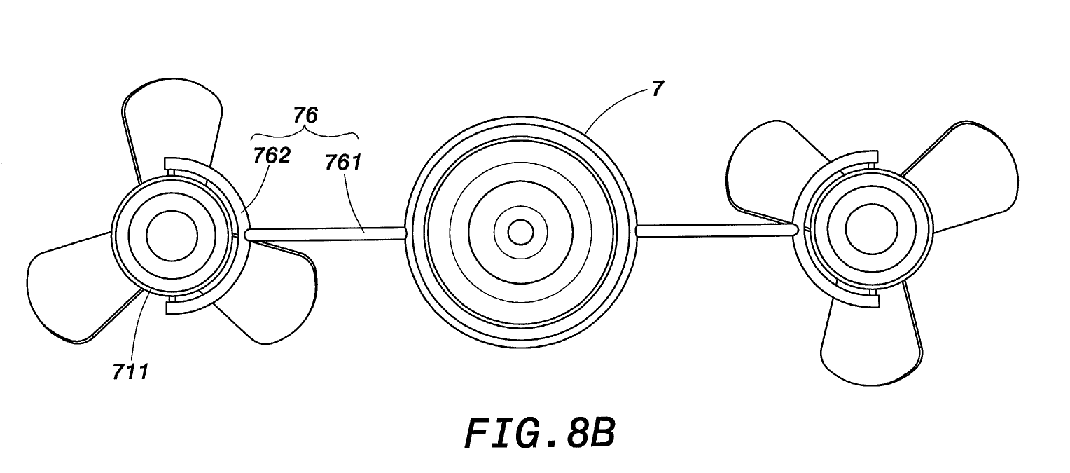

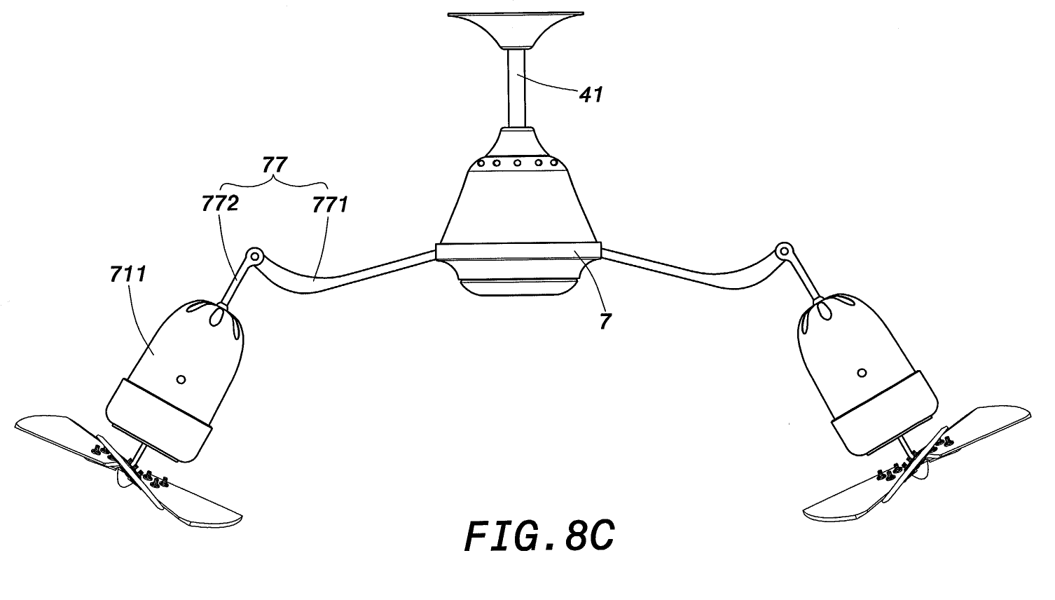

In addition to the above two parallel rotating arms 71, the multi-rotor ceiling fan of the present invention can have two symmetric Y-shaped rotating arms 75. A ringed body 751 is formed between the two symmetric Y-shaped rotating arms. 75. The ringed body can be exactly received in the lower housing cover 7. The diverged end of the Y-shaped rotating arm is pivotally joined with a fan 711. Or the multi-rotor ceiling fan of the present invention can have two symmetric Y-shaped rotating arms 76 shown in FIG. 8A. The straight rod end of each Y-shaped rotating arm 76 is directly screwed onto the lower housing cover 7 (or integrally formed with the lower housing cover 7, or fixed on the lower housing cover 7 by means of welding). The other end (diverged end) of each Y-shaped rotating arm 76 is pivotally joined with a fan 711. As shown in FIG. 8B, the Y-shaped rotating arm 76 is formed by connecting (or slipping, or screwing) a single transversal rod 761 with a diverged brace 762. The single transversal rod 761 is directly fixed on the lower housing cover 7 (or integrally formed with the lower housing cover 7, or fixed on the lower housing cover 7 by means of welding, or fixedly screwed onto the lower housing cover 7). The diverged brace at the other end is pivotally joined with a fan 711. Because the single transversal rod 761 occupies less space, a ceiling fan with three rotors or more can be provided. FIG. 8C shows another embodiment of the rotating arm of the present invention. The rotating arm 77 is composed of a curved hook rod 771 and a vertical rod 772. The vertical rod 772 is vertically connected to the tail end of a fan 711. The curved hook rod 771 is fixedly joined with the lower housing cover 7 in the same ways described above.

As shown in FIG. 7, a remote-control signal receiver (not shown) for receiving control instructions from a remote-control transmitter can further be installed in a ceiling disk 411 at the upper end of the boom 41, thereby changing the three-stage rotation speed of the fans 711 and on/off state of the lamp body 731 or stopping the fans 711. The revolution around the central axial rod 4 can thus be stopped or have three-stage speed.

Factors affecting the revolution speed around the central axial rod 4 include the rotating speed of the fan, the length of the rotating arm, the weight of the fan's motor, the weight of the rotating disk (e.g., increasing the thickness of the rotating disk or adding an adjustment zinc block on the rotating disk), and the angle between the fan and the rotating arm. In view of manufacturing and design, these five factors can be easily tempered to meet the requirement of controlling the revolution speed. For example, with other four factors not varied, the faster the rotation speed, the faster the revolution speed; the longer the rotating arm, the slower the revolution speed; the heavier the motor, the slower the revolution speed; the heavier the rotating disk, the slower the revolution speed; the smaller the angle relative to the horizontal, the slower the revolution speed (If the fan is parallel to the rotating arm, the revolution halts; if the angle between the fan and the rotating arm is 90 degrees, the revolution speed is the highest). Of course, a wired multi-stage control switch can also be exploited to control the revolution speed through the rotation speed of the fan.

In the prior art, the fan's motor has only a single rotation speed and uses a simple on/off switch so the user cannot select the rotation speed and the revolution speed. In the present invention, each motor has three-stage speed change and off functions. Three-stage revolution speed corresponding to the three-stage speed change can be accomplished. The consumer thus has different choices. For manufacturers, the rotation and revolution speeds can be adequately controlled through the adjustment on parameter of the revolving components through rotation disk, such as weight or load of rotation disk, rotors or length of rotating arm, etc.

The present invention replaces the original gear set (rotation braking set) with a bearing structure capable of synchronously moving with the rotating disk 6 so that the fans can revolve around the central axial rod 4 along a circular orbit with the two bearings 511 and 611 serving as the fulcrum of rotation without any vibration and sway when rotating and thus leading to revolution.

To sum up, in the present invention, a lengthwise multi-row bearing or two single-row bearings 511 and 611 can be installed at the vertically-joined portion of the central axial rod 4 with the inner housing cover 5 and the rotating disk 6 to achieve a stable revolution without any vibration and sway. A rotation braking set is not required. Moreover, the revolution is noiseless and smooth, and the situation of sudden deceleration or acceleration of the revolution will not arise. Because there is no rubbing component, there will be no over heat problem caused by excessive rubbing, and the malfunction rate is low. Furthermore, because there is no gear structure, there will be no mechanical load or friction to the revolution. Therefore, the parts thereof are hardly damaged so the maintenance expense will be low. Because there is wired or wireless control of the rotation speed of the fans, the present invention can have multi-stage speed change or can stop the revolution, or can even have the function of illumination.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A multi-rotor ceiling fan structure capable of stably revolving round a central axis thereof, comprising:
a rotating disk fixedly joined with one or more rotating arms, fans being pivotally joined at two ends of said rotating arm;
an inner housing cover fixedly joined on said rotating disk;
a central axial rod with an upper end fixedly joined at the ceiling and a lower end passing through centers of said rotating disk and said inner housing cover, a bearing structure placed between the centers of said rotating disk and said inner housing cover being tightly slipped onto said central axial rod; and
a power transmission set comprising a conductive sleeve and a seat body having a conductor, said seat body being fixedly disposed on said inner housing cover, said conductive sleeve being slipped onto an outer edge of said central axial rod, said conductor keeping electric contact with said conductive sleeve.

2. The multi-rotor ceiling fan structure as claimed in claim 1, wherein said bearing structure is a lengthwise multi-row bearing.

3. The multi-rotor ceiling fan structure as claimed in claim 1, wherein said bearing structure comprises two single-row bearings.

4. The multi-rotor ceiling fan structure claimed in claim 3, wherein one of said two single-row bearings is placed in a recessed portion at the center of said inner housing cover, and the other is placed in a projective portion at the center of said rotating disk.

5. The multi-rotor ceiling fan structure as claimed in claim 4, wherein said two single-row bearings are separated up and down by a ringed projective portion formed at the outer edge of said central axial rod.

6. The multi-rotor ceiling fan structure as claimed in claim 1, wherein a lower housing cover can further be fixed and cover from below said rotating disk.

7. The multi-rotor ceiling fan structure as claimed in claim 6, wherein a lamp disk in said lower housing cover can further be fixedly disposed at a lower end of said central axial rod protruding out of a bottom side of said rotating disk, and a lamp socket joining a lamp body is fixedly disposed in said lamp disk.

8. The multi-rotor ceiling fan structure as claimed in claim 7, wherein a lampshade can further be fixedly disposed at a lower opening of said lower housing cover, and a glass is fixedly disposed at a lower opening of said lampshade.

9. The multi-rotor ceiling fan structure as claimed in claim 1, wherein an engaging head can further be fixedly joined at an upper end of said central axial rod, the other end of said engaging head is fixedly joined with a boom, and an upper end of said boom is fixedly joined at the ceiling.

10. The multi-rotor ceiling fan structure as claimed in claim 9, wherein an upper housing cover can further be fixedly disposed at the engaging head, and said upper housing cover covers an outer periphery of said central axial rod and said inner housing cover.

11. The multi-rotor ceiling fan structure as claimed in claim 1, wherein said rotating arm is formed by joining a single transversal rod and a diverged brace, said single transversal rod is directly fixed at said lower housing cover, said brace at the other end is pivotally joined with a fan, and said rotating arm can apply to ceiling fan devices having three rotors or more because said single transversal rod occupies less space.

12. The multi-rotor ceiling fan structure as claimed in claim 1, wherein a ceiling disk capable of being attached to the ceiling is further disposed at an upper end of said central axial rod, a remote-control receiver for receiving control instructions from a remote-control transmitter can be installed in said ceiling disk, the rotation speed of fan has three-stage speed change or the rotation of fan can be stopped so the revolution speed has three-stage speed change or the revolution can be stopped.
